(19) United States
(12) Patent Application Publication
(10) Pub. No.: US 2009/0285057 A1
(43) Pub. Date: Nov. 19, 2009

(54) Stepping motor drive circuit and analog electronic clock

(76) Inventor: Kenji Ogasawara, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/454,251

(22) Filed: May 14, 2009

(30) Foreign Application Priority Data
May 15, 2008 (JP) 2008-128250

(51) Int. Cl. G04B 19/04; H02P 8/38

(52) U.S. Cl. 368/80; 318/696

(57) ABSTRACT

The present invention aims to generate a proper drive pulse in accordance with a motor. A plurality of duty generating circuits each generates a signal at a duty ratio different from one another. A main drive pulse generating circuit uses an output signal of the plurality of the duty generating circuits to generate a drive pulse, and a motor driver circuit rotates and drives a stepping motor. The stepping motor drives the hands of a display unit. When a rotation detecting circuit detects that the stepping motor is not rotated, a correction drive pulse generating circuit uses a signal from one of the duty generating circuits to output a correction drive pulse, and the motor driver circuit forcedly rotates and drives the motor by the correction drive pulse.

### BACKGROUND OF THE INVENTION

1. Field of the Invention

The present invention relates to a stepping motor drive circuit and an analog electronic clock using the stepping motor drive circuit.

2. Description of the Related Art

Heretofore, for an analog electronic clock, a stepping motor is used, which includes a stator having a rotor housing opening and a positioning portion to determine a stop position of a rotor; the rotor arranged inside the rotor housing opening; and a coil, in which an alternating signal is supplied to the coil to allow the stator to generate magnetic flux, thereby rotating the rotor and stopping the rotor at a position corresponding to the positioning portion.

As a drive method of the stepping motor, there is a method in which in driving a stepping motor by a main drive pulse, it is detected whether the stepping motor is rotated based on induced voltage generated in the stepping motor, depending on whether the stepping motor is rotated, the main drive pulse is changed to a main drive pulse having different pulse duration to drive the stepping motor, or the stepping motor is forcedly rotated by a correction drive pulse having pulse duration greater than that of the main drive pulse, whereby the stepping motor is rotated and driven at the minimum energy (for example, see Patent Documents JP-B-63-018148, JP-B-63-018149, and JP-B-57-018440).

FIG. 5 is a timing chart depicting waveforms of a main drive pulse and a correction drive pulse. As shown in FIG. 5A in driving a stepping motor by a comb-teeth main drive pulse P1, when a rotation detection signal Vrs at a predetermined level or above is detected, it is determined that the stepping motor is rotated. As shown in FIG. 5B, in rotating and driving the stepping motor by the main drive pulse P1, when the rotation detection signal Vrs at a predetermined level or above is not detected, it is determined that the stepping motor is not rotated, and then the stepping motor is rotated and driven by a comb-teeth correction drive pulse P2 wider than the main drive pulse P1. In addition, FIG. 5C is an example that the stepping motor is rotated and driven only by using a single kind of correction drive pulse P2.

An electronic clock mounted with the stepping motor drive circuit to drive the stepping motor at the minimum energy drives the motor by a plurality of drive pulses. At this time, the electronic clock is configured in which in response to the detected result of the rotation detecting circuit, a sequential circuit increases a pulse at a constant rate of raising energy until the pulse reaches a drivable pulse, whereas the sequential circuit decreases the pulse at every certain interval for confirming whether the pulse is excessively increased. Thus, power savings are made possible.

However, the following problems arise. Because the optimum pulse is varied depending on clock specifications, the number of pulse trains is increased more than necessary. It takes time until a pulse reaches the optimum pulse. When a pulse is temporarily increased because of disturbance, it takes time to return the pulse to the original pulse. Because a pulse generating circuit is configured to have a constant rate of raising energy, it is difficult to cope with random changes of pulses.

### SUMMARY OF THE INVENTION

The invention is made in view of the problems. The invention aims to generate a proper drive pulse in accordance with a motor.

According to an embodiment of the invention, a stepping motor drive circuit rotating and driving a stepping motor is provided, the stepping motor drive circuit including: a plurality of duty generating circuits configured to each generate a signal at a duty ratio different from one another; a motor drive means for generating a drive pulse by using an output signal of the plurality of the duty generating circuits to rotate and drive the stepping motor; and a rotation detecting means for detecting whether the stepping motor is rotated by the drive of the motor drive means, wherein the motor drive means rotates and drives the stepping motor by a drive pulse in accordance with a detected result by the rotation detecting means.

The plurality of the duty generating circuits each generates a signal at a duty ratio different from one another. The motor drive means uses an output signal of the plurality of the duty generating circuits to generate a drive pulse, and rotates and drives the stepping motor. The rotation detecting means detects whether the stepping motor is rotated by the drive of the motor drive means, and rotates and drives the stepping motor by a drive pulse in accordance with a detected result by the rotation detecting means.

Here, it may be configured in which the duty ratio of each of the duty generating circuits is able to be set independently.

In addition, it may be configured in which the drive pulse is a main drive pulse that rotates and drives the stepping motor in a normal state, and a correction drive pulse having energy larger than the main drive pulse that forcedly rotates and drives the stepping motor when the stepping motor is not rotated by the main drive pulse, and any one of the plurality of the duty generating circuits is used to generate both the main drive pulse and the correction drive pulse.

In addition, it may be configured in which the duty generating circuit having the largest duty ratio is used to generate both the main drive pulse and a correction drive pulse.

In addition, it may be configured in which only any one of the plurality of the duty generating circuits is made operable, and an output signal of the duty generating circuit is used to generate both the main drive pulse and a correction drive pulse.

In addition, it may be configured in which the motor drive means generates the drive pulse by combining outputs of the plurality of the duty generating circuits.

In addition, it may be configured in which the rotation detecting means is prohibited to operate, and the motor drive means rotates and drives the stepping motor only by the correction drive pulse.

In addition, according to an embodiment of the invention, an analog electronic clock is provided, which includes: a stepping motor configured to rotate and drive hands; and a stepping motor drive circuit configured to rotate and drive the stepping motor, wherein as the stepping motor drive circuit, the stepping motor drive circuit described above is used.

According to the stepping motor drive circuit of the embodiment of the invention, a motor can be driven by a proper drive pulse in accordance with the motor.

In addition, according to the analog electronic clock of the embodiment of the invention, a stepping motor can be driven by a proper drive pulse in accordance with a clock.

### BRIEF DESCRIPTION OF THE DRAWINGS

FIG. 1 is a block diagram depicting an analog electronic clock according to an embodiment of the invention;

FIG. 2 is a timing chart illustrative of the operations of a stepping motor drive circuit and the analog electronic clock according to the embodiment of the invention;

FIG. 3 is a timing chart illustrative of the operations of the stepping motor drive circuit and the analog electronic clock according to the embodiment of the invention;

FIG. 4 is a timing chart illustrative of the operations of the stepping motor drive circuit and the analog electronic clock according to the embodiment of the invention; and

FIGS. 5A, 5B and 5C are timing charts of a stepping motor drive circuit before.

### DESCRIPTION OF THE PREFERRED EMBODIMENT

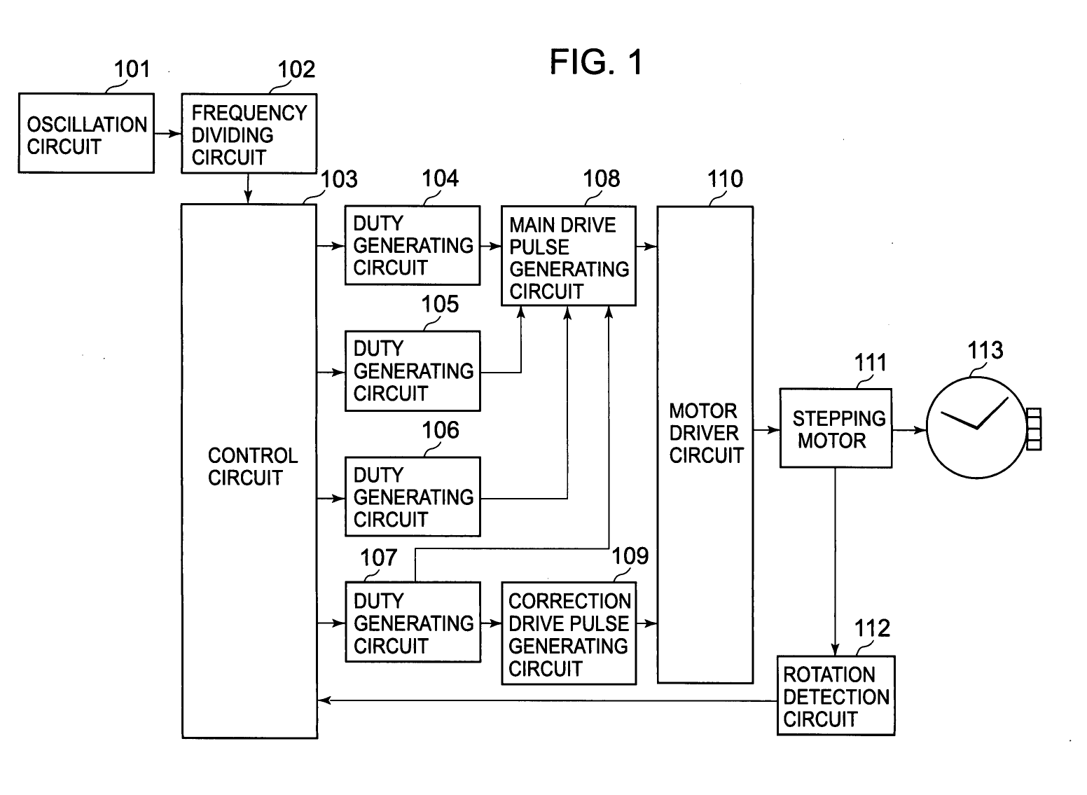

FIG. 1 is a block diagram depicting an analog electronic clock according to the embodiment of the invention, showing an exemplary analog electronic wristwatch.

In FIG. 1, the analog electronic clock has an oscillation circuit 101 that generates a signal at a predetermined frequency, a frequency dividing circuit 102 that divides the signal generated in the oscillation circuit 101 to generate a clock signal to be a time base, a control circuit 103 that conducts control of the individual electronic circuit components configuring the electronic clock and control of changes of drive pulses, a plurality of duty generating circuits 104 to 107 each of which generates a signal at a duty ratio different from one another, a main drive pulse generating circuit 108 that passes the signal outputted from one of the duty generating circuits 104 to 107 for a predetermined time period and outputs the signal as a comb-teeth main drive pulse, a correction drive pulse generating circuit 109 that passes the signal outputted from the duty generating circuit 107 for a predetermined time period and outputs the signal as a comb-teeth correction drive pulse, a motor driver circuit 110 that uses a main drive pulse from the main drive pulse generating circuit 108 and a correction drive pulse from the correction drive pulse generating circuit 109 and outputs a motor drive signal, and a stepping motor 111. In addition, the electronic clock has a rotation detecting circuit 112 that detects whether the stepping motor 111 is rotated based on an induced voltage signal from the stepping motor 111, and an analog indication unit 113 that has hands rotated and driven by the stepping motor 111 to indicate times of day.

The control circuit 101 conducts a timer operation of the current time of day based on the clock signal from the frequency dividing circuit 102, and controls the individual components such that the analog indication unit 113 indicates the current time of day.

Each of the duty generating circuits 104 to 107 continuously generates a comb-teeth signal at a duty ratio different from one another. The duty ratio is configured to increase in order of the duty generating circuits 104, 105, 106, and 107. The duty generating circuit 107 having the largest duty ratio is used to generate both the main drive pulse and the correction drive pulse.

In addition, the duty ratio of each of the duty generating circuits 104 to 107 is originally set depending on the characteristics and load of the stepping motor 111 in the stage of manufacture in order to set suited drive pulses in accordance with the types of clocks.

The main drive pulse 108 passes the comb-teeth signal outputted from one of the duty generating circuits 104 to 107 selected by the control circuit 103 for a predetermined time period, and outputs the signal as the main drive pulse to the motor driver circuit 110. In addition, in the case of outputting the correction drive pulse, the correction drive pulse generating circuit 109 passes the comb-teeth signal outputted from the duty generating circuit 107 for a predetermined time period, and outputs the signal as the correction drive pulse to the motor driver circuit 110.

The motor driver circuit 110 rotates and drives the stepping motor 111 based on the main drive pulse from the main drive pulse generating circuit 108 and the correction drive pulse from the correction drive pulse generating circuit 109. The stepping motor 111 rotates and drives the hands of the analog indication unit 113.

The rotation detecting circuit 112 is configured as similar to a publicly known rotation detecting circuit having been used, which is configured to detect a rotation detection signal Vrs exceeding a predetermined reference threshold voltage Vcomp when the stepping motor 111 is rotated, and configured not to detect the rotation detection signal Vrs exceeding the reference threshold voltage Vcomp when the stepping motor 111 is not rotated.

The control circuit 103 selects one from among the duty generating circuits 104 to 107, allows the main drive pulse generating circuit 108 to output the main drive pulse, and allows the correction drive pulse generating circuit 109 to output the correction drive pulse such that the main drive pulse of necessary energy or the correction drive pulse is outputted depending on whether the stepping motor 111 is rotated or not, which is detected by the rotation detecting circuit 112.

In addition, the oscillation circuit 101 and the frequency dividing circuit 102 configure a signal generating means, and the analog indication unit 113 configures a time indicating means. The rotation detecting circuit 112 configures a rotation detecting means, and the control circuit 103, the main drive pulse generating circuit 108, the correction drive pulse generating circuit 109, and the motor driver circuit 110 configure a motor drive means.

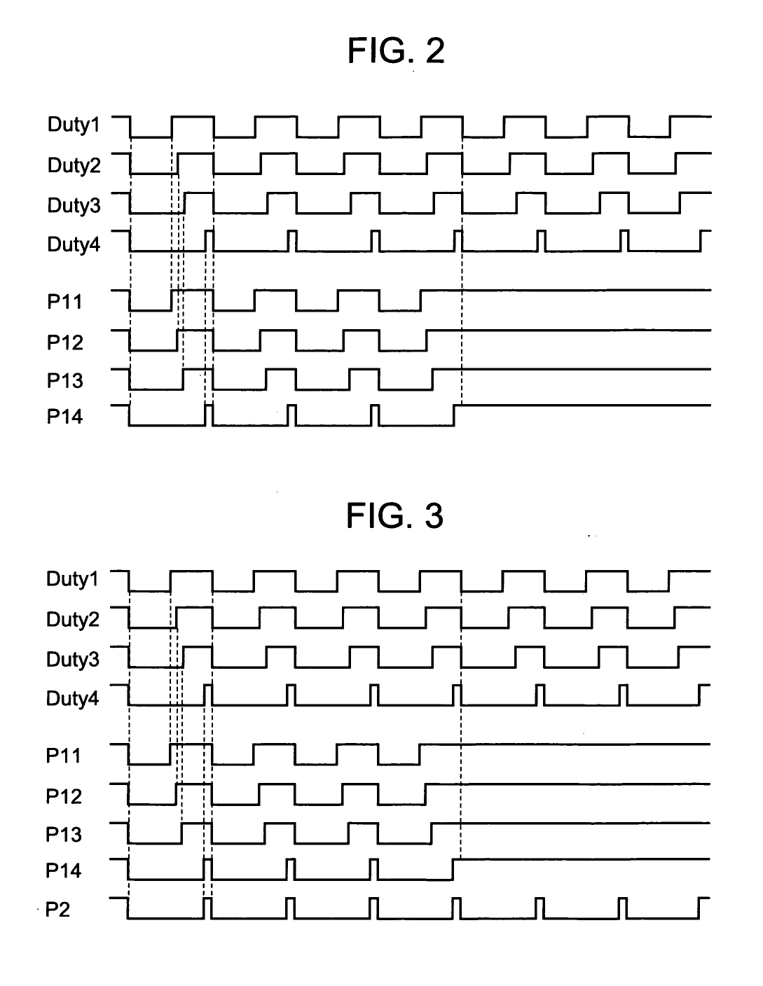

FIG. 2 is the timing of a stepping motor drive circuit according to the embodiment of the invention.

In FIG. 2, Duty 1 to Duty 4 denote signals outputted from the duty generating circuits 104 to 107, respectively. In addition, P11 to P14 denote main drive pulses outputted from the main drive pulse generating circuit 108. In addition, in the embodiment, as similar to FIG. 5, the main drive pulses P11 to P14 show exemplary comb-teeth drive pulses each formed of four pulses.

In FIGS. 1 and 2, the control circuit 103 controls the duty generating circuits 104 to 107 and the main drive pulse generating circuit 108 such that the main drive pulse generating circuit 108 outputs any one of outputs of the duty generating circuits 104 to 107 corresponding to necessary drive energy. In this case, it may be configured in which the selected one of the duty generating circuits outputs a signal, and the main drive pulse generating circuit 108 continuously outputs the inputted signal for a predetermined time period. In addition, it may be configured in which all the duty generating circuits 104 to 107 are controlled to output signals, and the main drive pulse generating circuit 108 selects any one from among the signals and outputs the selected signal as the main drive pulse.

Four pulses form a comb-teeth main drive pulse. When the main drive pulses are P11, P12, P13, and P14, the main drive pulse generating circuit 108 selects one from among the output signals Duty 1, Duty 2, Duty 3, and Duty 4 of the duty generating circuits 104, 105, 106, and 107, whereby the selected single main drive pulse is inputted from the main drive pulse generating circuit 108 to the motor driver circuit 110. The motor driver circuit 110 rotates and drives the stepping motor 111 by the main drive pulse.

FIG. 3 is an example that the output signal of the duty generating circuit 107 is used to generate a correction drive pulse P2.

In FIG. 3, as the result of rotating and driving the stepping motor 111 by the main drive pulse, when the rotation detecting circuit 112 detects that the stepping motor 111 is not rotated, the control circuit 103 controls the correction drive pulse generating circuit 109 to generate the correction drive pulse P2 with the use of the output signal Duty 4 of the duty generating circuit 107. The correction drive pulse P2 is a drive pulse having larger energy than that of the main drive pulse P14 (in the embodiment, the time range is long). The motor driver circuit 110 rotates and drives the motor 111 by the correction drive pulse P2, and after that, the motor driver circuit 110 rotates and drives the motor 111 by any one of the main drive pulses in accordance with a predetermined process procedure.

For example, the main drive pulse P1 is outputted with the signal Duty 1 at the duty ratio set by the duty generating circuit 104, the correction drive pulse P2 is outputted when the detected result by the rotation detecting circuit 112 shows that the motor 111 is not rotated, and the main drive pulse P12 is outputted with the signal Duty 2 at the duty ratio set by the duty generating circuit 105 for rotating and driving the motor 111 when driving the motor next time.

As described above, one of the duty generating circuits to generate the main drive pulse is also used as the duty generating circuit to generate the correction drive pulse P2, whereby a simple configuration can be provided.

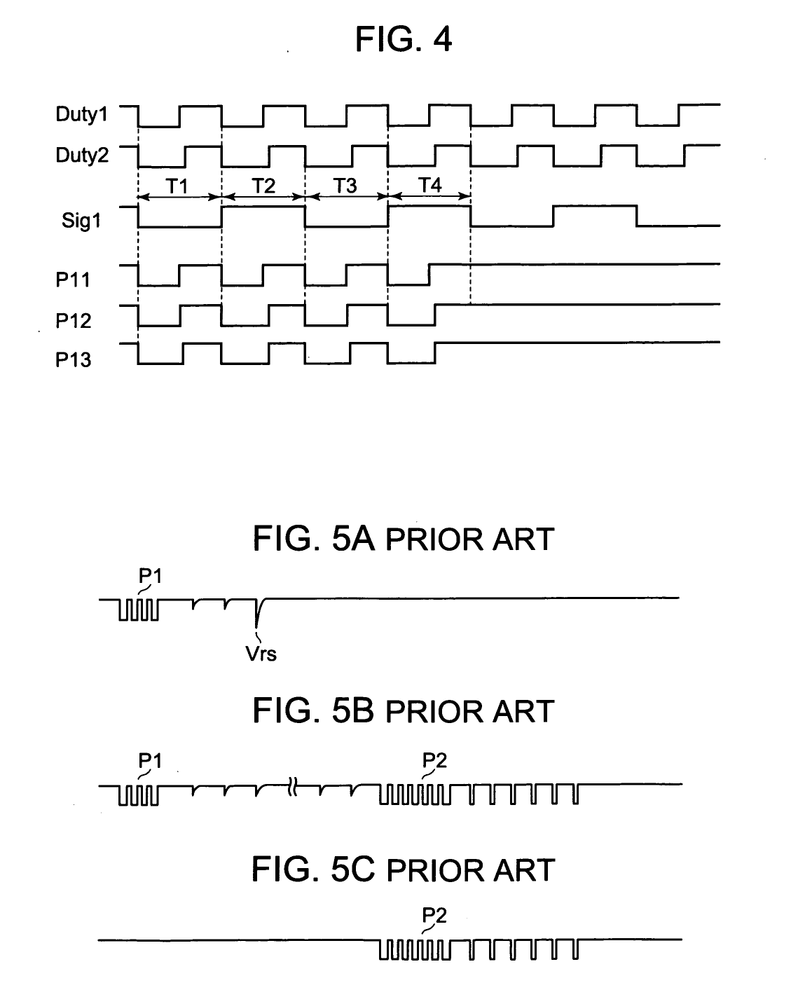

FIG. 4 is a timing chart according to another embodiment of the invention, and the same portions as those in FIG. 2 are designated the same numerals and signs. Although the circuit configuration is basically the same as that in FIG. 1, the duty generating circuit 106 is unnecessary.

The example in FIG. 4 is configured in which a plurality of duty generating circuits is used to each generate a main drive pulse, and a main drive pulse is also generated by combining the outputs of the plurality of the duty generating circuits. Accordingly, a fewer number of the duty generating circuits are used to generate many types of main drive pulses.

In FIG. 4, main drive pulses P11 and P13 are generated from output signals Duty 1 and Duty 2 of two duty generating circuits 104 and 105, respectively.

On the other hand, when a main drive pulse P12 is generated, the main drive pulse P12 can be obtained by alternately combining the outputs of the duty generating circuits 104 and 105. In other words, among four periods T1 to T4, the output signal Duty 1 of the duty generating circuit 104 is used in the periods T1 and T3, the output signal Duty 2 of the duty generating circuit 105 is used in the periods T2 and T4, and these output signals are combined to obtain the main drive pulse P12 having a middle duration between the main drive pulses P11 and P13. Thus, various drive pulses can be generated by a simple number of circuits.

As described above, the signals of the duty generating circuit 104 and the duty generating circuit 105 are alternately outputted at every chopped waveform, whereby the number of types of main drive pulses can be increased, and the resolution when drive energy is raised can be increased.

In addition, as another exemplary modification, it may be configured in which a circuit having a plurality of duty generating circuits is prepared in advance, only a selected one of the duty generating circuits is set operable depending on motor characteristics, for example, and the other duty generating circuits are prohibited to operate.

In addition, it may be configured in which the main drive pulse is not outputted, the rotation detecting circuit 112 is prohibited to operate, and only the correction drive pulse P2 is outputted to rotate and drive the stepping motor.

As described above, according to the stepping motor drive circuit of the embodiment of the invention, the duty generating circuits 104 to 107 generate signals at duty ratios different from one another. The main drive pulse generating circuit 108 uses the output signals of the duty generating circuits 104 to 107 to generate the drive pulse, and the motor driver circuit 110 rotates and drives the stepping motor 111. The stepping motor 111 drives the hands of the display unit 113. When the rotation detecting circuit 112 detects that the stepping motor 111 is not rotated, the correction drive pulse generating circuit 109 uses the signal from the duty generating circuit 107 to output the correction drive pulse, and then the motor driver circuit 110 forcedly rotates and drives the stepping motor 111 by the correction drive pulse.

As described above, it is configured to provide a plurality of the duty generating circuits 104 to 107 whose duty ratios can be set independently, whereby the stepping motor can be driven by a proper drive pulse in accordance with the stepping motor, and pulses can be varied in accordance with the type of clock by combining pulse trains.

In addition, the following advantages can be exerted. The optimum combination of pulse trains is made possible as matched with the specifications of individual clocks. Because necessary pulse trains are combined, pulses can be stabilized to the optimum pulse for a short time. Because only the duty generating circuits are provided more than one, the circuit scale remains small as the circuit to implement random changes of pulses. One of the duty generating circuits is also used to generate both the main drive pulse and the correction drive pulse, whereby the circuit scale remains small. It is prohibited to changeably use the duty generating circuits, and it is prohibited to output the main drive pulse, whereby the same circuits can be used to meet various drive methods. In addition, the duty generating circuits are combined, whereby the resolution when energy is raised can be increased with no additional circuit.

In addition, the embodiments of the invention are applicable to a stepping motor to drive a calendar, for example, other than hands.

In addition, as an exemplary application of the stepping motor, the electronic clock is taken and explained as an example. However, the embodiments of the invention are applicable to electronic appliances using a motor.

The stepping motor drive circuit according to the embodiments of the invention is applicable to various electronic appliances using a stepping motor.

In addition, the electronic clock according to the embodiments of the invention is applicable to various analog electronic clocks, including various analog electronic clocks with a calendar function such as an analog electronic wristwatch with a calendar function, and an analog electronic desktop clock with a calendar function.

What is claimed is:

1. A stepping motor drive circuit rotating and driving a stepping motor, comprising:
a plurality of duty generating circuits configured to each generate a signal at a duty ratio different from one another;
a motor drive means for generating a drive pulse by using an output signal of the plurality of the duty generating circuits to rotate and drive the stepping motor; and
a rotation detecting means for detecting whether the stepping motor is rotated by the drive of the motor drive means,
wherein the motor drive means rotates and drives the stepping motor by a drive pulse in accordance with a detected result by the rotation detecting means.

2. The stepping motor drive circuit according to claim 1, wherein the duty ratio of each of the duty generating circuits is able to be set independently.

3. The stepping motor drive circuit according to claim 1, wherein the drive pulse is a main drive pulse that rotates and drives the stepping motor in a normal state, and a correction drive pulse having energy larger than the main drive pulse that forcedly rotates and drives the stepping motor when the stepping motor is not rotated by the main drive pulse, and
any one of the plurality of the duty generating circuits is used to generate both the main drive pulse and the correction drive pulse.

4. The stepping motor drive circuit according to claim 2, wherein the drive pulse is a main drive pulse that rotates and drives the stepping motor in a normal state, and a correction drive pulse having energy larger than the main drive pulse that forcedly rotates and drives the stepping motor when the stepping motor is not rotated by the main drive pulse, and
any one of the plurality of the duty generating circuits is used to generate both the main drive pulse and the correction drive pulse.

5. The stepping motor drive circuit according to claim 3, wherein the duty generating circuit having the largest duty ratio is used to generate both the main drive pulse and a correction drive pulse.

6. The stepping motor drive circuit according to claim 4, wherein the duty generating circuit having the largest duty ratio is used to generate both the main drive pulse and a correction drive pulse.

7. The stepping motor drive circuit according to claim 3, wherein only any one of the plurality of the duty generating circuits is made operable, and an output signal of the duty generating circuit is used to generate both the main drive pulse and a correction drive pulse.

8. The stepping motor drive circuit according to claim 4, wherein only any one of the plurality of the duty generating circuits is made operable, and an output signal of the duty generating circuit is used to generate both the main drive pulse and a correction drive pulse.

9. The stepping motor drive circuit according to claim 1, wherein the motor drive means generates the drive pulse by combining outputs of the plurality of the duty generating circuits.

10. The stepping motor drive circuit according to claim 2, wherein the motor drive means generates the drive pulse by combining outputs of the plurality of the duty generating circuits.

11. The stepping motor drive circuit according to claim 3, wherein the motor drive means generates the drive pulse by combining outputs of the plurality of the duty generating circuits.

12. The stepping motor drive circuit according to claim 4, wherein the motor drive means generates the drive pulse by combining outputs of the plurality of the duty generating circuits.

13. The stepping motor drive circuit according to claim 5, wherein the motor drive means generates the drive pulse by combining outputs of the plurality of the duty generating circuits.

14. The stepping motor drive circuit according to claim 6, wherein the motor drive means generates the drive pulse by combining outputs of the plurality of the duty generating circuits.

15. The stepping motor drive circuit according to claim 1, wherein the rotation detecting means is prohibited to operate, and the motor drive means rotates and drives the stepping motor only by the correction drive pulse.

16. The stepping motor drive circuit according to claim 2, wherein the rotation detecting means is prohibited to operate, and the motor drive means rotates and drives the stepping motor only by the correction drive pulse.

17. The stepping motor drive circuit according to claim 3, wherein the rotation detecting means is prohibited to operate, and the motor drive means rotates and drives the stepping motor only by the correction drive pulse.

18. The stepping motor drive circuit according to claim 4, wherein the rotation detecting means is prohibited to operate, and the motor drive means rotates and drives the stepping motor only by the correction drive pulse.

19. The stepping motor drive circuit according to claim 5, wherein the rotation detecting means is prohibited to operate, and the motor drive means rotates and drives the stepping motor only by the correction drive pulse.

20. The stepping motor drive circuit according to claim 6, wherein the rotation detecting means is prohibited to operate, and the motor drive means rotates and drives the stepping motor only by the correction drive pulse.

21. An analog electronic clock comprising:
a stepping motor configured to rotate and drive hands; and
a stepping motor drive circuit configured to rotate and drive the stepping motor,
wherein as the stepping motor drive circuit, the stepping motor drive circuit according to claim 1 is used.
